(19) United States
(12) Patent Application Publication
(10) Pub. No.: US 2010/0133976 A1
(43) Pub. Date: Jun. 3, 2010

(54) Maxx fire spark plug

(76) Inventor: Max Siegel, Kearney, NE (US)

Correspondence Address: WILSON DANIEL SWAYZE, JR., 3804 CLEARWATER CT., PLANO, TX, 75025, US

(21) Appl. No.: 12/325,227

(22) Filed: Nov. 30, 2008

(51) Int. Cl. H01T 13/20

(52) U.S. Cl. 313/141

(57) ABSTRACT

A spark plug for vehicle may include a ground electrode, and a center electrode for cooperating with the ground electrode. The center electrode may include a spline member and the ground electrode may include an inward extending projection member. The spline member and the inward extending projection member may cooperate to generate a spark for the vehicle, and the spline member may be a male spline member. The center electrode may include a plurality of spline members spaced around the periphery of the central electrode, and the ground electrode may include a plurality of inward extending projection members spaced around the periphery of the ground electrode. The ground electrode may include a cylinder.

### BACKGROUND OF THE INVENTION

1. Technical Field of the Invention

The present invention relates generally to spark plugs for internal combustion engines. More particularly, the invention relates to an improved structure of a spark plug for an internal combustion engine of an automotive vehicle which ensures a high capability of the spark plug to ignite the air-fuel mixture.

2. Description of the Related Art

Conventional spark plugs for use in internal combustion engines generally include a metal shell, an insulator, a center electrode, and a ground electrode.

The metal shell has a threaded portion for fitting the spark plug into a combustion chamber of the engine. The insulator has a center bore formed therein, and is fixed in the metal shell such that an end thereof protrudes from an end of the metal shell. The center electrode is secured in the center bore of the insulator such that an end thereof protrudes from the end of the insulator. The ground electrode has a side surface, and is joined to the end of the metal shell such that the side surface thereof is opposed to and spaced from the end of the center electrode so as to form a spark gap therebetween.

In recent years, the demand for higher power output of an internal combustion engine has required increasing the sizes of intake and exhaust valves for the engine and securing a water jacket for cooling of the engine. This results in a decreased space available for installing a spark plug in the engine, thus requiring the spark plug to be slenderized.

For example, the threaded portion of the metal shell of a spark plug had an outer diameter of M14 as specified in JIS (Japanese Industrial Standards) in the past; however, the threaded portion is now required to have an outer diameter of equal to or less than M12 as specified in JIS.

Moreover, the engine types of high compression or lean burn have recently been used in engine design for the purpose of increasing power output or improving fuel economy. When the combustion condition of such a type engine comes to worsen, carbon and other unburned products will deposit on the surface of the insulator around the end thereof. Such deposit causes a problem of “carbon fouling”.

In a slenderized spark plug, the volume of an air pocket is accordingly reduced which is the space between an outer surface of the insulator and an inner surface of the metal shell. The reduced volume of the air pocket can cause generation of “surface-creeping sparks” which move from the center electrode of the spark plug along an outer surface of the insulator, and fly to the metal shell of the spark plug.

Such surface-creeping sparks are more frequently generated in a spark plug where the insulator thereof is fouled with carbon, since the electrically conductive carbon deposit on the surface of the insulator reduces an insulation resistance between the insulator and the metal shell.

To suppress generation of surface-creeping sparks, U.S. Pat. No. 6,147,441 discloses a spark plug which has the threaded portion of a metal shell with an outer diameter in the range of 10-12 mm. The spark plug has specified ranges for dimensional parameters, such as a length of a discharge gap (i.e., a spark gap size), a width of a gas volume (i.e., an air pocket size), a protruding length of an insulator with respect to a fitting piece (i.e., a metal shell), a diameter of a center electrode, an end diameter of a noble metal tip (i.e., noble metal chip), and a protruding height of the noble metal tip with respect to the center electrode.

Moreover, to solve the above-described problem of carbon fouling, U.S. Pat. No. 5,929,556 discloses another type of spark plug. The spark plug has a structure where a center electrode retracts from an end of an insulator, so that, when the insulator is fouled with carbon, the carbon deposit on the surface of the insulator can be burned off during generation of surface-creeping sparks.

However, the problem of carbon fouling has become very serious to a recent spark plug used in an engine of high compression or lean burn type. A large amount of carbon deposit builds up on the surface of the insulator around the end of the same, so that the insulation resistance of the portion of the insulator protruding from the end of the metal shell comes to decrease, resulting in a short circuit of the spark plug.

U.S. Pat. No. 7,122,948 discloses a spark plug that includes a metal shell, an insulator, a center electrode, and a ground electrode. The metal shell has a threaded portion with an outer diameter of equal to or less than 10 mm, or equal to 12 mm for installing the spark plug in an internal combustion engine. The dimensional parameters in the structure of the spark plug satisfy the dimensional relationships defined through experimental investigation. The structure ensures a high capability of the spark plug to ignite the air-fuel mixture even when the insulator thereof is fouled with carbon.

### SUMMARY

A spark plug for vehicle may include a ground electrode, and a center electrode for cooperating with the ground electrode.

The center electrode may include a spline member and the ground electrode may include an inward extending projection member.

The spline member and the inward extending projection member may cooperate to generate a spark for the vehicle, and the spline member may be a male spline member.

The center electrode may include a plurality of spline members spaced around the periphery of the central electrode, and the ground electrode may include a plurality of inward extending projection members spaced around the periphery of the ground electrode.

The ground electrode may include a cylinder.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a side view of the center electrode of the present invention;

FIG. 2 illustrates a cutaway portion of the spark plug of the present invention;

FIG. 3 illustrates a top view of the ground electrode of the present invention;

FIG. 4 illustrates a top view of the center electrode of the present invention;

FIG. 5 illustrates a top view of the ground electrode and the center electrode of the present invention;

FIG. 6 illustrates a perspective view of a portion of the distal end of the spark plug of the present invention;

FIG. 7 illustrates a cutaway view of the ground electrode of the present invention;

FIG. 8 illustrates a top view of the distal end of the spark plug of the present invention;

FIG. 9 illustrates a top view of the distal end of another spark plug of the present invention;

FIG. 10 illustrates a top view of the distal end of another spark plug of the present invention;

FIG. 11 illustrates a top view of the distal end of another spark plug of the present invention;

FIG. 12 illustrates a top view of the distal end of another spark plug of the present invention;

FIG. 13 illustrates a cross-sectional view of a portion of another spark plug of the present invention;

FIG. 14 illustrates a cross-sectional view of another spark plug of the present invention

FIG. 15 illustrates a cross-sectional view of another spark plug of the present invention;

FIG. 16 illustrates a cross-sectional view of another spark plug of the present invention;

FIG. 17 illustrates a cross-sectional view of another spark plug of the present invention;

FIG. 18 illustrates a top view of the spark plug of the present invention.

### DETAILED DESCRIPTION

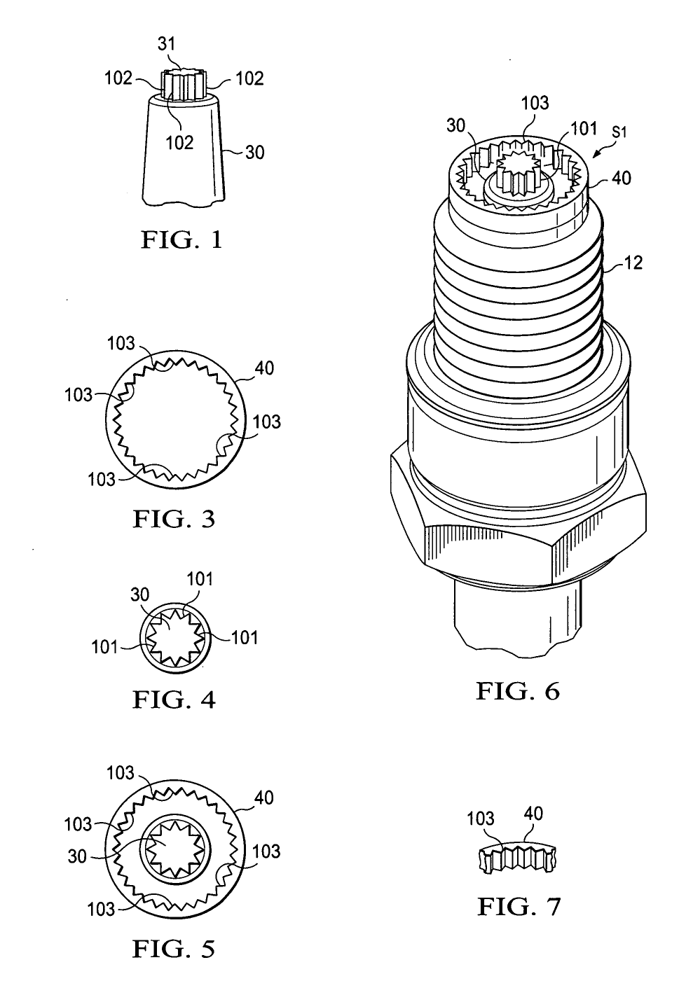

FIG. 1 illustrates a portion of the central electrode 30 of the present invention. The central electrode 30 may include a male spine member 101 at the distal end 31 of the central electrode 30. FIG. 1 shows that male spine members 101 may extend around the periphery of the central electrode 30.

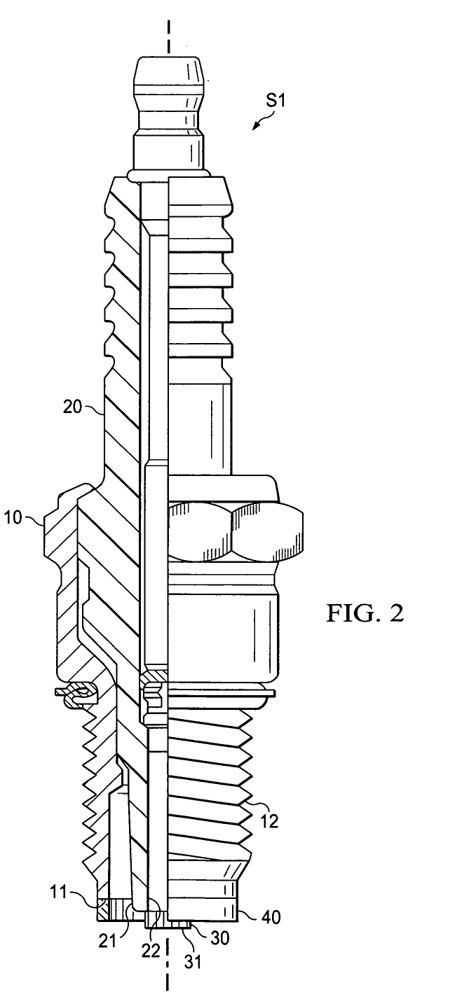

FIG. 2 shows an overall structure of a spark plug S1 according to the invention.

The spark plug S1 may be designed for use in internal combustion engines of vehicles such as automotive vehicles or other types of vehicles. The installation of the spark plug S1 in an internal combustion engine may be achieved by fitting it into a combustion chamber (not shown) of the engine through a threaded bore provided in the engine head (not shown).

As shown in FIG. 2, the spark plug S1 may include a metal shell 10, an insulator 20, a center electrode 30, and a ground electrode 40.

The cylindrical metal shell 10 may be made of a conductive metal material, for example a low-carbon steel. The metal shell 10 may have a threaded portion 12 on the outer periphery thereof for fitting with a threaded connection the spark plug S1 into the combustion chamber of the engine as described above.

The threaded portion 12 of the metal shell 10 may have an outer diameter equal to or less than 10 mm or other appropriate size. This range may correspond to the range of M10 as specified in JIS (Japanese Industrial Standards).

The tubular insulator 20, which may be made of alumina ceramic, may be fixed and partially contained in the metal shell 10 such that an end 21 of the insulator 20 may protrude from an end 11 of the metal shell 10.

The cylindrical center electrode 30 may be made of a highly heat conductive metal material such as Cu as the core material and a highly heat-resistant, corrosion-resistant metal material such as a Ni (Nickel)-based alloy as the clad material.

The center electrode 30 may be secured in a center bore 22 of the insulator 20, so that it is isolated from the metal shell 10. The center electrode 30 may be partially included in the metal shell 10 together with the insulator 20 such that an end 31 of the center electrode 30 protrudes from the end 21 of the insulator 20.

The ground electrode 40 may be made of a Ni-based alloy consisting mainly of Ni.

The ground electrode 40 may have one end portion joined, for example by welding, to the end 11 of the metal shell 10. The other end portion of the ground electrode 40 may have a side surface 42 that is opposed to the end 31a of the center electrode 30.

FIG. 3 illustrates a top view of the ground electrode 40 which may be a cylinder or other appropriate shape and may include an inward extending projection member 103 in a spaced relationship on the interior surface of the ground electrode 40. A plurality of the extending projection members 103 may be formed around the periphery of the interior surface of the ground electrode 40. The inward extending projection members 103 may be tapered and form a point.

FIG. 4 illustrates a top view of the center electrode 30 and illustrates the male spine members 101 formed around the periphery of the center electrode 30.

FIG. 5 illustrates a top view of the center electrode 30 and the ground electrode 40 which may be a cylinder or other appropriate shape and may include an inward extending projection member 103 in a spaced relationship on the interior surface of the ground electrode 40. The inward extending projection members 103 may be tapered and form a point or alternatively may not be tapered.

FIG. 5 illustrates the center electrode 30 and illustrates the male spine members 101 formed around the periphery of the center electrode 30.

FIG. 6 illustrates a perspective view of the distal end of the spark plug S1 which may include the threaded portion 12.

FIG. 7 illustrates a perspective view of a portion of the ground electrode 40 and shows the inward extending projection members 103.

FIG. 6 illustrates a top view of the center electrode 30 and the ground electrode 40 which may be a cylinder or other appropriate shape and may include an inward extending projection member 103 in a spaced relationship on the interior surface of the ground electrode 40. The inward extending projection members 103 may be tapered and form a point or alternatively may not be tapered.

FIG. 6 illustrates the center electrode 30 and illustrates the male spine members 101 formed around the periphery of the center electrode 30.

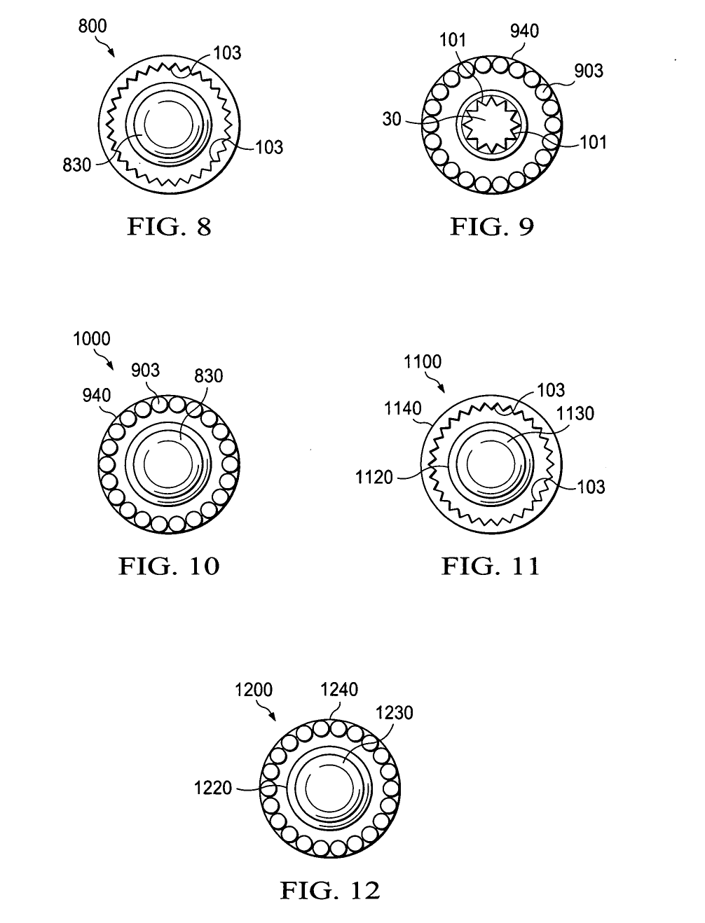

FIG. 8 illustrates a top view of the distal end of the spark plug 800 which may include a cylindrical center electrode 830 and inward extending projection members 103 extending around the interior surface of the ground electrode 40.

FIG. 9 illustrates a top view of the distal end of the spark plug 800 which may include cylindrical members 903 which may extend in the longitudinal direction of the spark plug 800 and are in a spaced relationship and may be connected to the interior surface of the ground electrode 940. FIG. 9 illustrates the center electrode 30 which may have the male spline members 101 which may be positioned on the exterior surface of the center electrode 30.

FIG. 10 illustrates a top view of the distal end of the spark plug 1000 which may include the cylindrical center electrode 830 and the cylindrical members 903 positioned around the interior of the ground electrode 940. The rounded surfaces of either the cylindrical center electrode 830 or the rounded surfaces of the cylindrical members 903 may require a higher voltage in order for a spark to jump between the central electrode and the ground electrode. This higher voltage increases performance of the spark plug.

FIG. 11 illustrates a top view of the distal end of the spark plug 1100. FIG. 11 illustrates a central electrode 1130 which may have a portion encased by an insulator 1120 which may be sufficiently wide such that the radial thickness of the insulator 1120 may be greater than the diameter of the central electrode 1130. FIG. 11 illustrates the extending projection member 103 around the periphery of the ground electrode 1140.

FIG. 12 illustrates a top view of the distal end of the spark plug 1200. FIG. 12 illustrates a central electrode 1230 which may have a portion encased by an insulator 1220 which may be sufficiently wide such that the radial thickness of the insulator 1220 may be greater than the diameter of the central electrode 1230. FIG. 12 illustrates the cylinder member 1203 around the periphery of the ground electrode 1240.

The wide insulator may discourage spark and the corresponding excess energy to extend down into the barrel of the spark plug. Thus, the teachings of FIGS. 11 and 12 may discourage misfiring and provide a significant benefit.

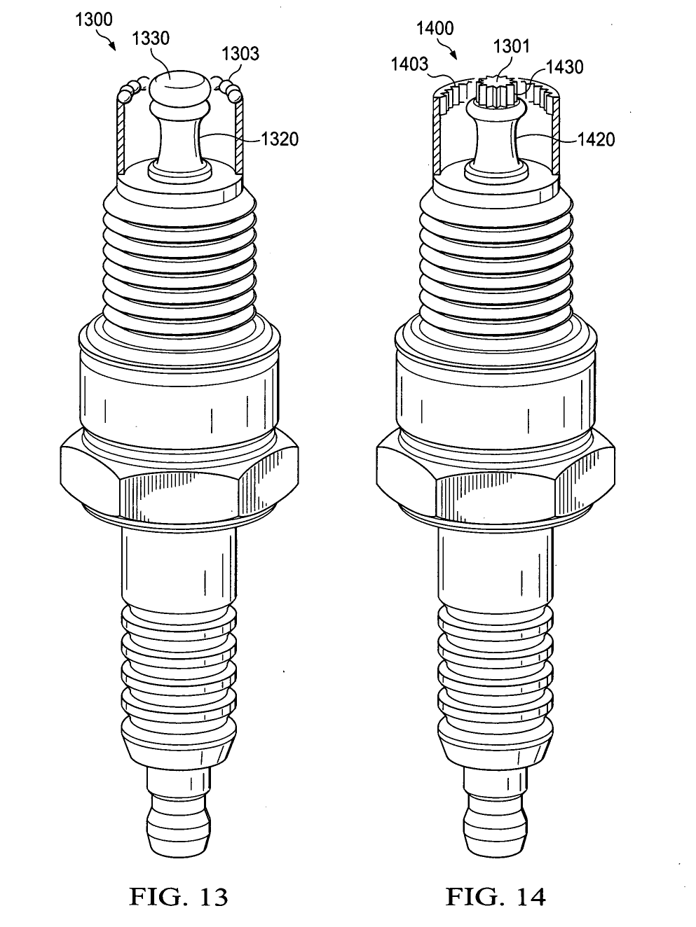

FIG. 13 illustrates a side view of a spark plug 1300 which may include a cylinder member 1303, central electrode 1330 and an insulator 1320 which may include a parabolic shape and may have a concave surface. This may provide a fat, thick, cooling tower type central electrode 1330.

FIG. 14 illustrates a side view of a spark plug 1400 which may include an extending projection members 1403, central electrode 1430 which may include a male spline member 1401 and a insulator 1420 which may include a parabolic shape and may have a concave surface. This may provide a fat, thick, cooling tower type central electrode 1430.

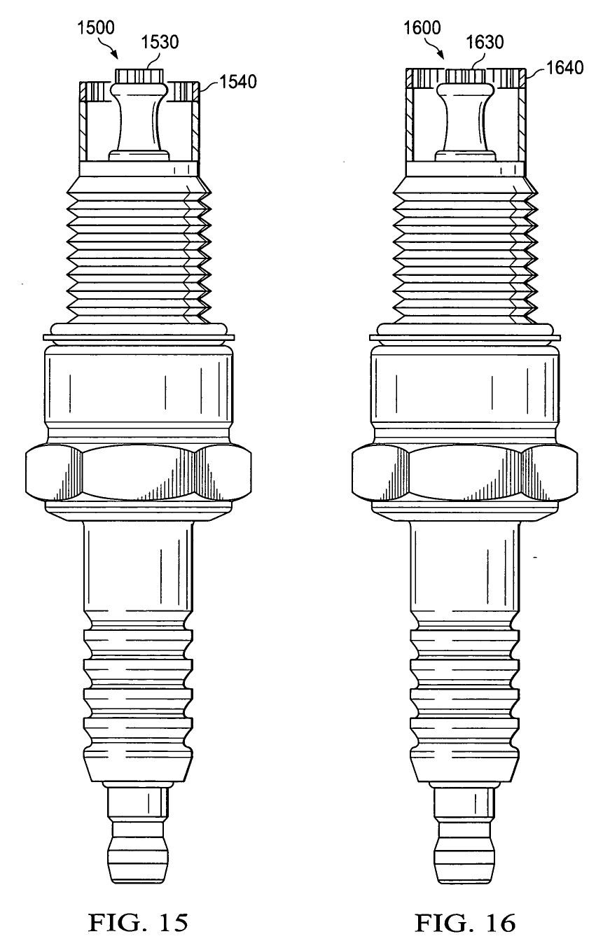

FIG. 15 illustrates a side view of a spark plug 1500 which may include a central electrode 1530 which extends outward and beyond the ground electrode 1540. The central electrode 1530 may be applied to any of the above described elements.

FIG. 16 illustrates a side view of spark plug 1600 which may include a central electrode 1630 which may be recessed or substantially in the same plane as the ground electrode 1640. The central electrode 1630 may be applied to any of the above described elements.

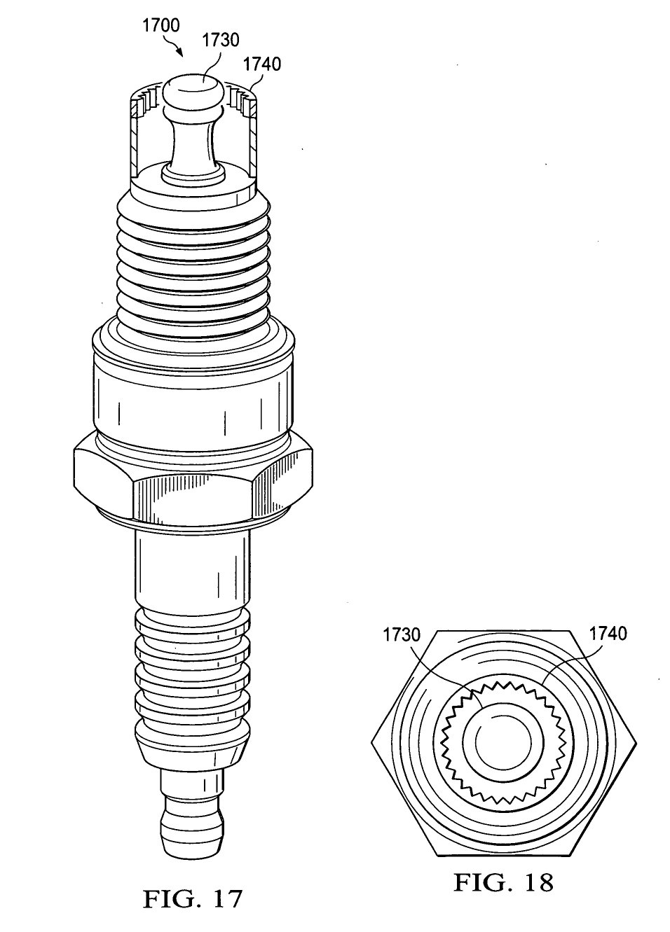

FIG. 17 illustrates a side view of spark plug 1770 which may include a central electrode 1730 which may include a sphere which cooperates with the male spline member 1740.

FIG. 18 illustrates a top view of spark plug 1770 which may include a central electrode 1730 which may include a sphere which cooperates with the male spline member 1740.

The central electrode as described above could be made of hard steel to resist wear such as stainless or titanium or other suitable materials. This would aid in use of the spark plug for up to 100,000 miles.

The present invention provides an open faced omni-directional firing ring.

The spark plug design, as illustrated as S1, will allow the modern internal combustion engine to reach new levels of performance, economy, reduced emissions and engine longevity

The present invention may include an “omni directional” outer firing ring which may be shown as ground electrode 40 and which may include an inward projecting member 103 or points which may be formed in any of a 360 degree configuration or a partial 360° configuration pointing substantially inward toward the positive electrode which may be referred to as the Omni Firing Ring/Grounding Electrode, may be referred to as the inner firing ring or the center electrode 30. This may allow the spark to travel in any of 360 degrees about the face of the plug.

The inner firing ring may include an inward projecting member 103 which may be referred to as a “splined” center firing electrode 30 which may also have points facing substantially radially outward towards the outer firing ring or grounding electrode 40 to produce a splined shaft. This gives a substantially 360 degree “firing face,” point to point with few or no rounded surfaces. The spark plug of the present invention may be pre-gapped at the factory for different applications. Gaps may range from substantially 30 thousandths or fewer to in excess of 300 thousandths or greater. This spark may be designed to run a large gap. With the spark plug S1 of the present invention, it is possible for multiple sparks at the same time or a single spark from any point on the outer firing ring to any point on the inner firing ring; consequently, the spark may travel all around the possible 360 degree striking area to aid in providing an efficient burn of fuel.

The spark plug S1 of the present invention may fire as quickly as demand warrants to generate a spark that may travel where it is needed, sometimes splitting many times at the same time to result in more burnt fuel that has been hitherto achieved.

The spark plug up the present invention does not require an overhanging grounding electrode which may result in the spark being covered up and consequently reduced and may result in a spark which does not glow red hot. All cylinders may receive the same uniform flame front. Car racers will no longer have to “index” their spark plugs! Aircraft owners will no longer need to worry about fouling plugs in flight and will finally be able to see higher performance from a new idea in the industry.

The spark plug of the present invention is resistant to carbon fouling. With a standard plug you have a center electrode and up to four standard grounding electrodes. Independent of how the grounding electrode may be shaped, the grounding electrodes could cause fouling. Using the present invention with open face, point-to-point 360 degree firing design, fouling is virtually eliminated. There are a near infinite number of paths for the spark to take, eliminating the fouled spark plug. Also, a cooler plug could be run for increased performance.

The present invention does not require rounded off gaps or re-gapping plugs. The spark plug of the present invention may be pre-gapped. The design of the present invention substantially eliminates maintenance, as a consequence, performance may be achieved by use of the present invention.

This plug body may be formed from stainless steel for long life or other suitable material. The fire ring/grounding electrode may be also formed from stainless steel or other suitable material, resulting in a spark plug that may be wear resistant and very durable. The center electrode may be also stainless steel or whatever material the industry deems to be the longer lasting for the application.

The spark plug of the present invention may last 100,000 miles.

The advantages of the spark plug of the present invention are not limited to:
Achieve cleaner exhaust emissions.
Generate more power per piston stroke.
Maintain the valves, combustion chamber, intake, piston and exhaust ports much cleaner.
Prohibit misfiring.
Increase fuel economy.
Substantially increase engine life.
Reduce operating costs by allowing double the miles, or more, on each set of plugs.
Increase power and mileage.
Maintain the vehicle to stay “in tune” much longer.

With oil at an all-time high and rising, with our environment in danger, with drivers being burdened with the high cost of fuel and with engines being closely to repair, the spark plug of the present invention can provide significant advantages with a clean burning ignition.

Again, smaller gaps may be accommodated by simple design, but the larger gaps may cause an engine's ignition coil to generate a higher voltage spark right in the “quench zone” of the combustion chamber, the above advantages may be achieved with multiple sparks around a substantial 360 degree pattern, point-to-point pattern.

This plug S1 may be very easy to mass manufacture due to the open face design because there's no grounding electrode to weld on.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A spark plug for vehicle, comprising:
a ground electrode;
a center electrode for cooperating with the ground electrode;
wherein the center electrode includes a spline member and the ground electrode includes an inward extending projection member.

2. A spark plug for vehicle as in claim 1, wherein the spline member and the inward extending projection member cooperate to generate a spark for the vehicle.

3. A spark plug for vehicle as in claim 1, wherein the spline member is a male spline member.

4. A spark plug for vehicle as in claim 1, wherein the center electrode includes a plurality of spline members spaced around the periphery of the central electrode.

5. A spark plug for vehicle as in claim 1, wherein the ground electrode includes a plurality of inward extending projection members spaced around the periphery of the ground electrode.

6. A spark plug for vehicle as in claim 1, wherein the ground electrode includes a cylinder.

7. A spark plug for vehicle as in claim 1, wherein the ground electrode includes cylinder members connected to the interior of the ground electrode.

8. A spark plug for vehicle as in claim 1, wherein the central electrode includes a cylinder.

9. A spark plug for vehicle as in claim 7, wherein the central electrode includes a cylinder.
